(19) United States
(12) Patent Application Publication
(10) Pub. No.: US 2021/0076343 A1
(43) Pub. Date: Mar. 11, 2021

(54) USER TERMINAL AND RADIO BASE STATION

(71) Applicant: NTT DOCOMO, INC., Tokyo (JP)

(72) Inventors: Hiroki Harada, Tokyo (JP); Jing Wang, Beijing (CN)

(73) Assignee: NTT DOCOMO, INC., Tokyo (JP)

(21) Appl. No.: 17/045,095

(22) PCT Filed: Apr. 5, 2018
(86) PCT No.: PCT/JP2018/014646

§ 371 Date: Oct. 2, 2020

(51) Int. Cl. H04W 56/00; H04W 88/02; H04W 24/10; H04B 17/318; H04L 5/00

(52) U.S. Cl. CPC H04W 56/001; H04W 88/02; H04L 5/0092; H04B 17/318; H04W 24/10

(57) ABSTRACT

A user terminal according to one aspect of the present disclosure includes a receiving section that receives a synchronization signal, and a control section that determines a maximum allowable bandwidth for measurement of a received signal strength to be used for determination of a received quality of the synchronization signal. With this, it is possible to appropriately determine a maximum bandwidth for which measurement of a received signal strength is allowed.

### TECHNICAL FIELD

The present disclosure relates to a user terminal and a radio base station in next-generation mobile communication systems.

### BACKGROUND ART

In the UMTS (Universal Mobile Telecommunications System) network, the specifications of Long Term Evolution (LTE) have been drafted for the purpose of further increasing high speed data rates, providing lower latency and so on (see Non-Patent Literature 1). For the purpose of further high capacity, advancement of LTE (LTE Rel. 8, Rel. 9), and so on, the specifications of LTE-A (LTE-Advanced, LTE Rel. 10, Rel. 11, Rel. 12, Rel. 13) have been drafted.

Successor systems of LTE (referred to as, for example, “FRA (Future Radio Access),” “5G (5th generation mobile communication system),” “5G+ (plus),” “NR (New Radio),” “NX (New radio access),” “FX (Future generation radio access),” “LTE Rel. 14,” “LTE Rel. 15” (or later versions), and so on) are also under study.

In existing LTE systems (for example, LTE Rel. 8 to Rel. 13), a user terminal (UE (User Equipment)) detects a synchronization signal (SS) to synchronize with a network (for example, a base station (eNB (eNode B))) and identifies a cell to connect to (for example, identifies the cell with reference to a cell ID (Identifier)). Such a process is also referred to as “cell search.” The synchronization signal includes, for example, a PSS (Primary Synchronization Signal) and/or SSS (Secondary Synchronization Signal).

The UE also receives broadcast information (for example, master information blocks (MIBs), system information blocks (SIBs), and the like) to acquire a configuration information for communication with the network (which may be also referred to as “system information” and the like).

The MIBs may be transmitted on a broadcast channel (PBCH (Physical Broadcast Channel)), and the SIBs may be transmitted on a downlink (DL) shared channel (PDSCH (Physical Downlink Shared Channel)).

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

In future radio communication systems (for example, also referred to as “3GPP Rel. 15 (or later versions),” “NR,” “5G,” “5G+,” and the like), measurement using a synchronization signal block (SSB) is employed.

In the measurement using an SSB, it is assumed, for example, to determine a received quality of a synchronization signal (for example, SS-RSRQ (Synchronization signal reference signal received quality)), based on a received power of the synchronization signal (for example, SS-RSRP (Synchronization signal reference signal received power)) and a received signal strength (for example, RSSI (Received Signal Strength Indicator)).

However, when a bandwidth for which measurement of the received signal strength is allowed (maximum allowable bandwidth) is not determined appropriately, the accuracy in measurement of a received quality may decrease if a received power of at least one of other channels and signals acquired based on traffic fails to be reflected sufficiently.

Thus, an object of the present disclosure is to provide a user terminal and a radio base station that can appropriately determine a maximum bandwidth for which measurement of a received signal strength is allowed.

### Solution to Problem

A user terminal according to one aspect of the present disclosure includes a receiving section that receives a synchronization signal, and a control section that determines a maximum allowable bandwidth for measurement of a received signal strength to be used for determination of a received quality of the synchronization signal.

### Advantageous Effects of Invention

According to one aspect of the present disclosure, it is possible to appropriately determine a maximum bandwidth for which measurement of a received signal strength is allowed.

### BRIEF DESCRIPTION OF DRAWINGS

FIG. 1 is a diagram to show an example of determination of a maximum allowable bandwidth for NR carrier RSSI measurement according to a first aspect;

FIG. 2 is a diagram to show another example of the determination of a maximum allowable bandwidth for NR carrier RSSI measurement according to the first aspect;

FIG. 3 is a diagram to show another example of the determination of a maximum allowable bandwidth for NR carrier RSSI measurement according to the first aspect;

FIGS. 4A and 4B are diagrams to show examples of determination of a maximum allowable bandwidth for NR carrier RSSI measurement according to a second aspect;

FIG. 5 is a diagram to show another example of the determination of a maximum allowable bandwidth for NR carrier RSSI measurement according to the second aspect;

FIG. 6 is a diagram to show an example of a schematic structure of a radio communication system according to one embodiment;

FIG. 7 is a diagram to show an example of an overall structure of a radio base station according to one embodiment;

FIG. 8 is a diagram to show an example of a functional structure of the radio base station according to one embodiment;

FIG. 9 is a diagram to show an example of an overall structure of a user terminal according to one embodiment;

FIG. 10 is a diagram to show an example of a functional structure of the user terminal according to one embodiment; and

FIG. 11 is a diagram to show an example of a hardware structure of the radio base station and the user terminal according to one embodiment.

### DESCRIPTION OF EMBODIMENTS

For future radio communication systems (also referred to as, for example, “3GPP Rel. 15 (or later versions),” “NR,” “5G,” “5G+,” and the like), the following types of measurement are studied:

(1) intra-frequency measurement without measurement gap (MG);

(2) intra-frequency measurement with MG; and

(3) inter-frequency measurement.

The intra-frequency measurement without MG in (1) above is also referred to as “same frequency measurement not requiring RF retuning.” The intra-frequency measurement with MG in (2) above is also referred to as “same frequency measurement requiring RF retuning.” For example, in a case that no measurement target signal is included in the band of an active BWP (BandWidth Part), RF retuning is required even in same frequency measurement, and hence the measurement in (2) above is employed.

In a measurement gap (MG), a user terminal switches (retunes) the radio frequency (RF) to use from that of a serving carrier to that of a non-serving carrier, and, after measurement using a reference signal or the like, switches the radio frequency to use from that of the non-serving carrier to that of the serving carrier.

Here, the BWP corresponds to one or more partial frequency bands in a component carrier (CC) (a carrier, a cell, or an NR carrier) configured for NR. The BWP may be referred to as a “partial frequency band,” a “partial band,” and the like. The BWP may include at least one of a downlink BWP (DL BWP) and an uplink BWP (UL BWP).

The inter-frequency measurement in (3) above is also referred to as “different frequency measurement.” It is assumed that the different frequency measurement uses MG. However, when the UE reports a UE capability of gap less measurement to a base station (which may be referred to as, for example, a “BS (Base Station),” a “transmission/reception point (TRP),” an “eNB (eNodeB),” a “gNB (NR NodeB),” and the like), different frequency measurement without MG is possible.

In NR, since the RF is switched during measurement of a same frequency carrier or a different frequency carrier with MG, transmission/reception in the serving cell is not possible.

In LTE, NR, and the like, at least one of a reference signal received power (RSRP), a received signal strength indicator (RSSI), a reference signal received quality (RSRQ), and a SINR (Signal to Interference plus Noise Ratio) of the non-serving carrier may be measured, for same frequency measurement and/or different frequency measurement.

Here, the RSRP is a received power of a desired signal and is measured by using at least one of a cell-specific reference signal (CRS), a channel state information-reference signal (CSI-RS), and the like, for example. The RSSI is a total received power of the received power of the desired signal and an interference and noise power. The RSRQ is the ratio of the RSRP to the RSSI.

The desired signal may be a signal included in a synchronization signal block (SSB). The SSB is a signal block including a synchronization signal (SS) and a broadcast channel (also referred to as a “broadcast signal,” a “PBCH,” an “NR-PBCH,” and the like) and may be referred to as an “SS/PBCH block” and the like.

The SS may include a PSS (Primary Synchronization Signal), an SSS (Secondary Synchronization Signal), an NR-PSS, an NR-SSS, and the like. The SSB is constituted of one or more symbols (for example, OFDM symbols). In the SSB, each of the PSS, the SSS, and the PBCH may be mapped to one or more different symbols, the PSS, the SSS, and the PBCH being mapped to different symbols. For example, the SSB may be constituted of four or five symbols in total including the PSS of one symbol, the SSS of one symbol, and the PBCH of two or three symbols.

Note that measurement performed by using the SS (or the SSB) may be referred to as “SS (or SSB) measurement.” As the SS (or SSB) measurement, for example, SS-RSRP, SS-RSSI, SS-RSRQ, or SS-SINR measurement may be performed.

By the way, It is assumed that the user terminal determines a received quality of a synchronization signal (for example, SS-RSRQ (Synchronization signal reference signal received quality)), based on a received power of the synchronization signal (for example, SS-RSRP (Synchronization signal reference signal received power)) and a received signal strength in an NR carrier (for example, RSSI (Received Signal Strength Indicator) or NR carrier RSSI).

For example, the SS-RSRQ may be defined as follows.

SS-RSRQ=N*SS-RSRP/NR carrier RSSI

Here, N may denote the number of resource blocks included in a maximum bandwidth (maximum allowable bandwidth or measurement bandwidth) for which measurement of an NR carrier RSSI is allowed.

The SS-RSRP is defined by a linear average of power contributions of a resource element that transmits the synchronization signal (SS). A time resource for SS-RSRP measurement may be defined within an SMTC window period. The SS-RSRP may be measured only between the reference signals corresponding to SS/PBCH blocks of the same SS/PBCH block index and the same physical-layer cell ID (Physical-layer cell identity). In a case that a higher layer indicates an SS/PBCH block for which SS-RSRP measurement is to be performed, the SS-RSRP may be measured in the indicated SS/PBCH block. Note that the SS-RSRP may be measured by using at least one of the PSS, the SSS, and other signals (for example, a CSI-RS).

The NR carrier RSSI configures a linear average of the total received powers of OFDM symbols corresponding to a measurement time resource and a measurement bandwidth. The measurement bandwidth may be constituted of N resource blocks. The NR carrier RSSI may include interference and thermal noise from all the sources including a co-channel serving cell and non-serving cell. The time resource for NR carrier RSSI measurement may be defined within an SMTC window period.

It is studied that the NR carrier RSSI is measured for an SS/PBCH block as in SS-RSRP. Specifically, it is studied that the maximum allowable bandwidth for NR carrier RSSI measurement is a bandwidth of an SS/PBCH block (for example, 20 PRBs) similar to the bandwidth for SS-RSRP measurement.

However, an NR carrier RSSI measured based on the bandwidth of an SS/PBCH block as the maximum allowable bandwidth may not appropriately reflect traffic load. Hence, it is desired to flexibly control a maximum bandwidth for which measurement of an NR carrier RSSI is allowed.

In view of this, the inventors of the present invention studied a method of appropriately determining a maximum bandwidth for which measurement of an NR carrier RSSI to be used for determination of an SS-RSRP is allowed, and reached the present invention.

One embodiment of the present disclosure will be described in detail with reference to the drawings as follows. In the following, to determine a “maximum allowable bandwidth” may include to determine at least one of the position (for example, a frequency position) and a bandwidth of a maximum allowable band for an NR carrier RSSI.

In the following, a “bandwidth” of at least one of an SS/PBCH block (SSB), a CORESET, and a DL BWP may be interpreted as “at least one of a band and a bandwidth.”

Moreover, in the following, for example, the higher layer signaling may be any one or combinations of RRC (Radio Resource Control) signaling, MAC (Medium Access Control) signaling, broadcast information, and the like.

For example, the MAC signaling may use MAC control elements (MAC CEs), MAC PDUs (Protocol Data Units), and the like. For example, the broadcast information may be master information blocks (MIBs), system information blocks (SIBs), minimum system information (RMSI (Remaining Minimum System Information)), and the like.

### (First Aspect)

In a first aspect, a description will be given of determination of at least one maximum allowable bandwidth (maximum allowable band/bandwidth) for measurement of an NR carrier RSSI (NR carrier RSSI measurement). The user terminal measures an NR carrier RSSI in at least part of a determined maximum allowable bandwidth (maximum allowable band).

### <Same Frequency SS-RSRQ Measurement>

The user terminal may determine a maximum allowable bandwidth for NR carrier RSSI measurement, based on at least one of the following conditions.

Whether an activated DL BWP (active DL BWP) includes an SSB

Whether a DL BWP configured by higher layer signaling (configured DL BWP) includes an SSB

<<1.1 Case that Active DL BWP Includes SSB>>

Specifically, in a case that an active DL BWP includes an SSB, the user terminal may determine a maximum allowable bandwidth for NR carrier RSSI measurement to be the bandwidth of the active DL BWP.

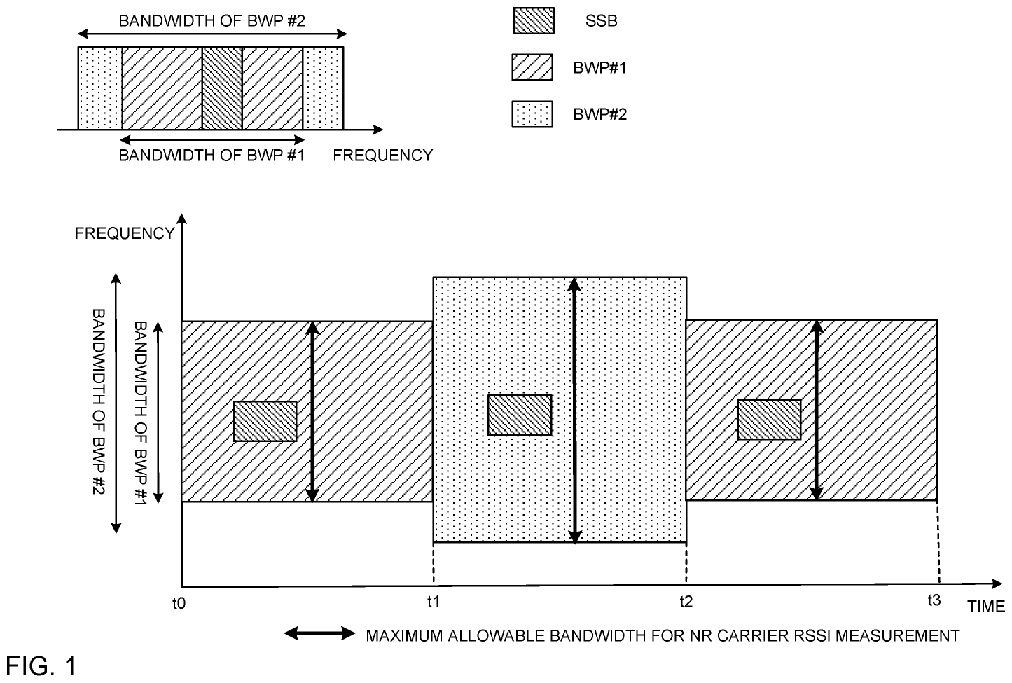

FIG. 1 is a diagram to show an example of determination of a maximum allowable bandwidth for NR carrier RSSI measurement according to the first aspect. In FIG. 1, it is assumed that BWPs #1 and #2 are configured for the user terminal by higher layer signaling. Note that, although an example that BWP #1 is included in BWP #2 is shown in FIG. 1, this is by no means limiting. Moreover, although an example that BWP #1 is active in t0 to t1 and t2 to t3 and BWP #2 is active in t1 to t2 is shown in FIG. 1, this is by no means limiting.

Since active DL BWP #1 includes an SSB in each of t0 to t1 and t2 to t3 in FIG. 1, the user terminal may determine active DL BWP #1 as the NR carrier RSSI measurement band and the bandwidth of the active DL BWP #1 as the maximum allowable bandwidth of the NR carrier RSSI measurement band.

Similarly, since active DL BWP #2 includes an SSB in t1 to t2 in FIG. 1, the user terminal may determine active DL BWP #2 as the NR carrier RSSI measurement band and the bandwidth of the active DL BWP #2 as the maximum allowable bandwidth of the NR carrier RSSI measurement band.

In FIG. 1, the maximum allowable band (and the maximum allowable bandwidth) for NR carrier RSSI measurement is controlled in accordance with switching of the active BWP. Hence, an influence of the amount of interference based on traffic can be reflected using an NR carrier RSSI.

<<1.2 Case that Active DL BWP does not Include SSB>>

In a case that an active DL BWP does not include an SSB, the user terminal may determine a maximum allowable bandwidth for NR carrier RSSI measurement, based on whether at least one DL BWP configured by higher layer signaling includes an SSB.

<<1.2.1 Case that Configured D1 BWP Includes SSB>>

In a case that at least one DL BWP configured by higher layer signaling includes an SSB, the user terminal may determine a maximum allowable bandwidth for NR carrier RSSI measurement, by using at least one of first to third determination examples below.

### First Determination Example

In the first determination example, the maximum allowable bandwidth for NR carrier RSSI measurement may be determined to be the smallest or greatest bandwidth of at least one DL BWP configured by higher layer signaling and including an SSB.

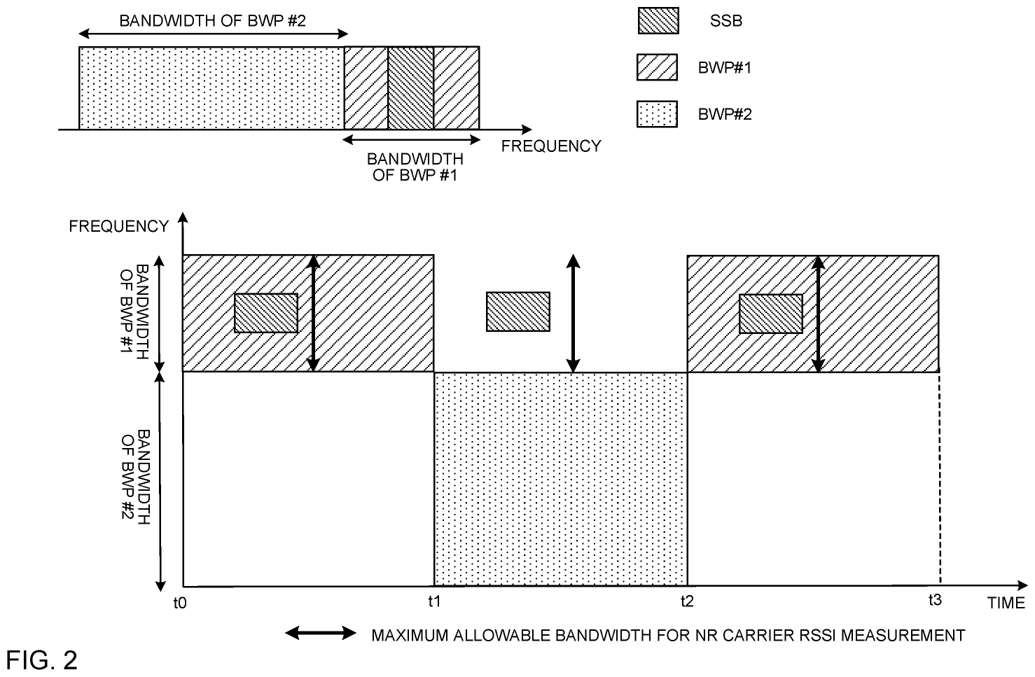

FIG. 2 is a diagram to show another example of the determination of a maximum allowable bandwidth for NR carrier RSSI measurement according to the first aspect. FIG. 2 is different from FIG. 1 in that active BWP #2 does not include an SSB in t1 to t2. For FIG. 2, differences from FIG. 1 will be mainly described.

In FIG. 2, although active BWP #2 does not include an SSB, BWP #1 configured for the user terminal includes an SSB. Hence, the user terminal may determine BWP #1 including an SSB as the maximum allowable bandwidth for NR carrier RSSI measurement.

In FIG. 2, even in a case that active BWP #2 does not include an SSB, it is possible to appropriately determine the maximum allowable bandwidth for NR carrier RSSI measurement.

### Second Determination Example

In the second determination example, the maximum allowable bandwidth for NR carrier RSSI measurement may be determined to be the bandwidth of an SS/PBCH block specified by the radio base station.

For example, information related to same frequency measurement using an SS/PBCH block (also referred to as “same frequency measurement information,” “MeasObjectNR,” or the like) may be configured for the user terminal by higher layer signaling, and the same frequency measurement information may include information indicating that a measurement target signal is the SS/PBCH block and indicating the configuration of the SS/PBCH block (also referred to as “SS/PBCH block information,” “SSB-ConfigMobility,” and the like) and frequency position information (ssbFrequency) of the SS/PBCH block. The user terminal may determine the maximum allowable bandwidth for NR carrier RSSI measurement to be the bandwidth of the SS/PBCH block indicated by the SS/PBCH block information in the same frequency measurement information.

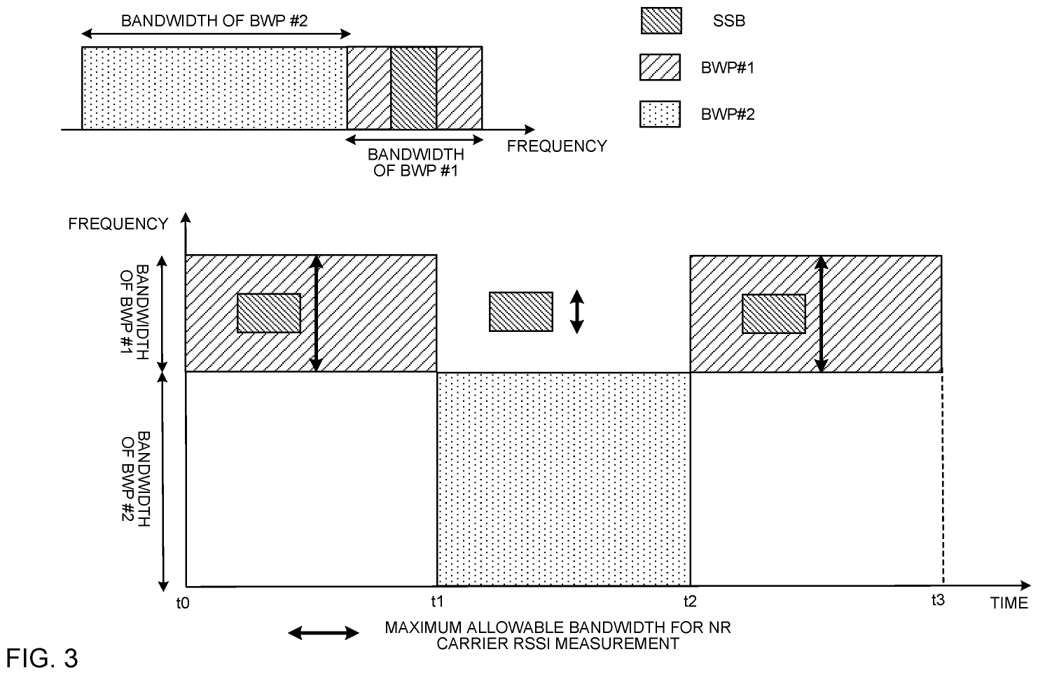

FIG. 3 is a diagram to show another example of the determination of a maximum allowable bandwidth for NR carrier RSSI measurement according to the first aspect. FIG. 3 is different from FIG. 1 in that active BWP #2 does not include an SSB in t1 to t2. For FIG. 3, differences from FIG. 1 will be mainly described.

In FIG. 3, although active BWP #2 does not include an SSB, BWP #1 configured for the user terminal includes an SSB. Hence, the user terminal may determine the SSB included in BWP #1 as the NR carrier RSSI measurement band and the bandwidth of the SSB as the maximum allowable bandwidth for NR carrier RSSI measurement band.

In FIG. 3, even in a case that active BWP #2 does not include an SSB, it is possible to appropriately determine a maximum allowable bandwidth for NR carrier RSSI measurement.

### Third Determination Example

In the third determination example, a maximum allowable bandwidth for NR carrier RSSI measurement may be determined to be the bandwidth of a control resource set (CORESET) configured by a PBCH (for example, a MIB (Master Information Block)).

In a case that no CORESET is configured by a PBCH, the maximum allowable bandwidth for NR carrier RSSI measurement may be determined to be the bandwidth of an SS/PBCH block specified by the radio base station. The SS/PBCH block may be specified by the SS/PBCH block information in the same frequency measurement information.

As in the third determination example, in a case that the maximum allowable bandwidth for NR carrier RSSI measurement is determined to be at least one bandwidth of the CORESET configured by the PBCH, the user terminal can determine a maximum allowable band/bandwidth for NR carrier RSSI measurement irrespective of whether a configured BWP includes an SSB (refer to a second determination example in 1.2.2 to be described later) as will be described later.

<<1.2.2 Case that Configured DL BWP does not Includes SSB>>

In a case that all the DL BWPs configured by higher layer signaling do not include an SSB, the user terminal may determine the maximum allowable bandwidth for NR carrier RSSI measurement, by using at least one of first and second determination examples below.

### First Determination Example

In the first determination example, the maximum allowable bandwidth for NR carrier RSSI measurement may be determined to be the bandwidth of an SS/PBCH block specified by the radio base station. The SS/PBCH block may be specified by the SS/PBCH block information in the same frequency measurement information.

### Second Determination Example

In the second determination example, the maximum allowable bandwidth for NR carrier RSSI measurement may be determined to be the bandwidth of a control resource set (CORESET) configured by a PBCH (for example, MIBs).

In a case that no CORESET is configured by a PBCH, the maximum allowable bandwidth for NR carrier RSSI measurement may be determined to be the bandwidth of an SS/PBCH block specified by the radio base station. The SS/PBCH block may be specified by the SS/PBCH block information in the same frequency measurement information.

### <Different Frequency SS-RSRQ Measurement>

The user terminal may determine the maximum allowable band for NR carrier RSSI measurement to be an SS/PBCH block in a measurement target carrier. The user terminal may determine the maximum allowable bandwidth for NR carrier RSSI measurement to be the bandwidth of the SS/PBCH block in the measurement target carrier.

The SS/PBCH block in the measurement target carrier may be specified by the radio base station. For example, information related to different frequency measurement using an SS/PBCH block (also referred to as “different frequency measurement information,” “MeasObjectNR,” or the like) may be configured for the user terminal by higher layer signaling, and the different frequency measurement information may include information indicating that a measurement target signal is the SS/PBCH block and indicating the configuration of the SS/PBCH block (also referred to as “SS/PBCH block information,” “SSB-ConfigMobility,” and the like) and frequency position information (ssbFrequency) of the SS/PBCH block.

### (Second Aspect)

In a second aspect, a description will be given of another determination example of a maximum allowable band/bandwidth for NR carrier RSSI measurement.

### <Same Frequency SS-RSRQ Measurement>

The user terminal may determine a maximum allowable band/bandwidth for NR carrier RSSI measurement, based on at least one of the following conditions.

Whether each of all DL BWPs configured by higher layer signaling (configured DL BWPs) includes an SSB

Whether at least one DL BWP configured by higher layer signaling (configured DL BWP) does not include an SSB

<<2.1 Case that Each of all Configured DL BWPs Includes SSB>>

In a case that each of all the configured DL BWPs includes an SSB, the maximum allowable band/bandwidth for NR carrier RSSI measurement may be determined by using at least one of first and second determination examples below.

### First Determination Example

In the first determination example, in a case that each of all the configured DL BWP includes an SSB, the user terminal may determine the maximum allowable band for NR carrier RSSI measurement to be an active DL BWP. Moreover, the user terminal may determine the maximum allowable bandwidth for NR carrier RSSI measurement to be the bandwidth of the active DL BWP.

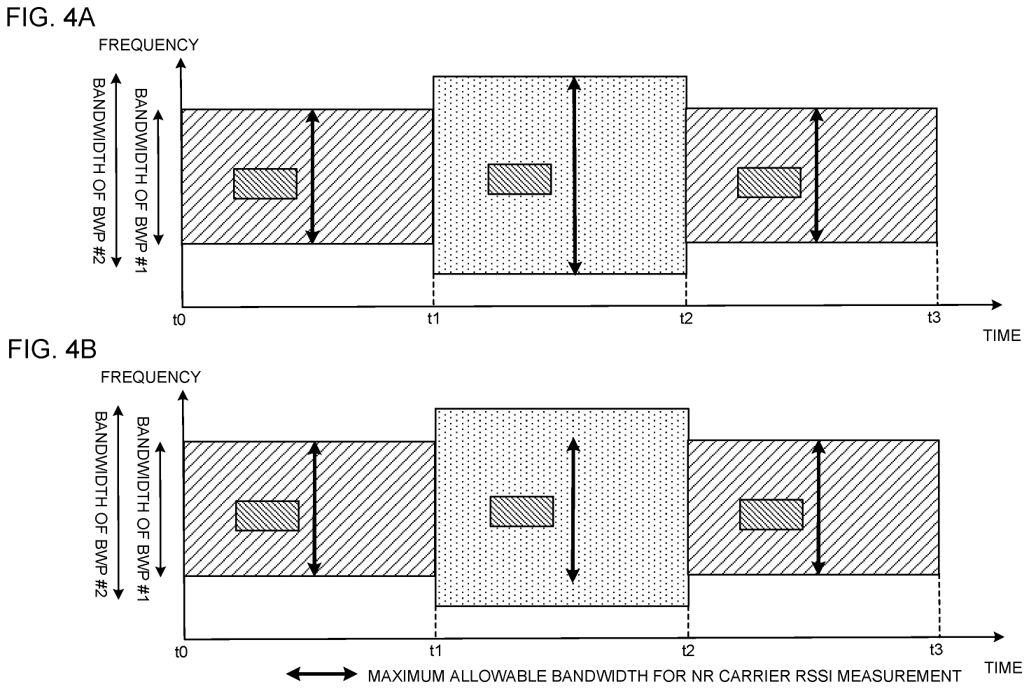

FIG. 4A is a diagram to show an example of determination of the maximum allowable bandwidth for NR carrier RSSI measurement according to the second aspect. Preconditions in FIG. 4A is similar to those in FIG. 1. In FIG. 4A, each of BWPs #1 and #2 configured for the user terminal includes an SSB. Thus, the user terminal may determine the maximum allowable band (and maximum allowable bandwidth) for NR carrier RSSI measurement to be an active DL BWP (and the bandwidth of the active DL BWP).

In FIG. 4A, the maximum allowable band (and the maximum allowable bandwidth) for NR carrier RSSI measurement is controlled in accordance with switching of the active BWP. Hence, an influence of the amount of interference based on traffic can be reflected using an NR carrier RSSI.

### Second Determination Example

In the second determination example, in a case that each of all the configured DL BWPs includes an SSB, the user terminal may determine the maximum allowable band for NR carrier RSSI measurement to be a configured DL BWP having the smallest bandwidth (or the greatest bandwidth). Moreover, the user terminal may determine the maximum allowable bandwidth for NR carrier RSSI measurement to be the smallest bandwidth (or the greatest bandwidth).

FIG. 4B is a diagram to show another example of the determination of the maximum allowable bandwidth for NR carrier RSSI measurement according to the second aspect. FIG. 4B is different from FIG. 4A in that BWP #1 having the smallest bandwidth is determined as the maximum allowable band for NR carrier RSSI measurement even when an active BWP is BWP #2 in t1 to t2.

In FIG. 4B, the maximum allowable band (and the maximum allowable bandwidth) for NR carrier RSSI measurement is not controlled even when the active BWP is switched. Hence, it is possible to prevent processing related to NR carrier RSSI measurement by the user terminal from being complicated.

<<2.2 Case that at Least One Configured DL BWP does not Include Ssb>>

In a case that at least one configured DL BWP does not include an SSB, the maximum allowable band/bandwidth for NR carrier RSSI measurement may be determined by using at least one of first to third determination examples below.

### First Determination Example

In the first determination example, when at least one configured DL BWP does not include an SSB, the maximum allowable bandwidth for NR carrier RSSI measurement may be determined to be the bandwidth of an SS/PBCH block specified by the radio base station. The SS/PBCH block may be specified by the SS/PBCH block information in the same frequency measurement information.

### Second Determination Example

In the second determination example, when at least one configured DL BWP does not include an SSB, the maximum allowable bandwidth for NR carrier RSSI measurement may be determined to be the smallest or greatest bandwidth among that of at least one DL BWP configured by higher layer signaling and including an SSB.

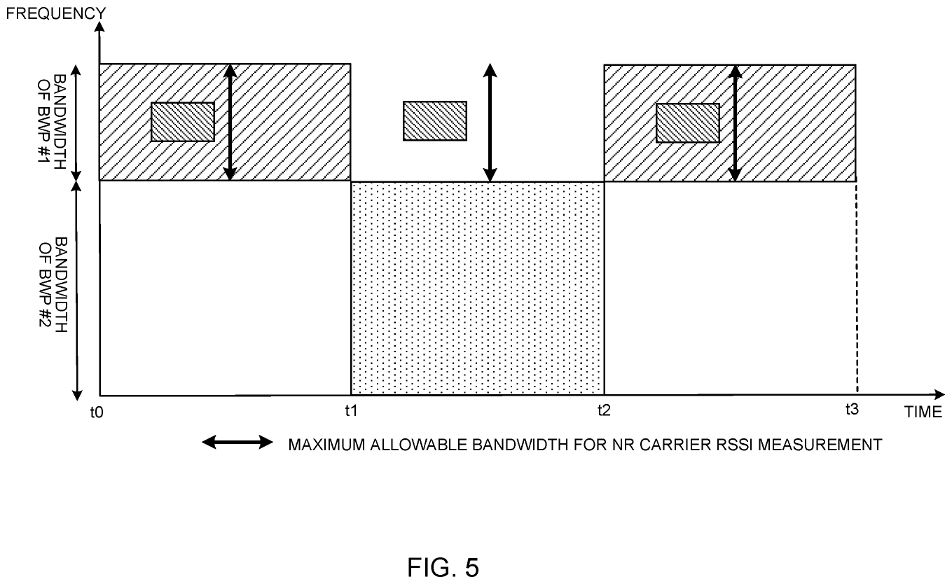

FIG. 5 is a diagram to show another example of the determination of a maximum allowable bandwidth for NR carrier RSSI measurement according to the second aspect. FIG. 5 is different from FIGS. 4A and 4B in that BWP #2 does not include an SSB. For FIG. 5, differences from FIG. 4 will be mainly described.

In FIG. 5, only BWP #1 out of BWPs #1 and #2 configured for the user terminal includes an SSB. Hence, the user terminal may determine BWP #1 as the NR carrier RSSI measurement band and the bandwidth of BWP #1 as the maximum allowable bandwidth for NR carrier RSSI measurement band.

In FIG. 5, the maximum allowable band (and the maximum allowable bandwidth) for NR carrier RSSI measurement is not controlled even when the active BWP is switched. Hence, it is possible to prevent processing related to NR carrier RSSI measurement by the user terminal from being complicated.

### Third Determination Example

In the third determination example, when at least one configured DL BWP does not include an SSB, the maximum allowable bandwidth for NR carrier RSSI measurement may be determined to be the bandwidth of a control resource set (CORESET) configured by a PBCH (for example, MIBs).

In a case that no CORESET is configured by a PBCH, the maximum allowable bandwidth for NR carrier RSSI measurement may be determined to be the bandwidth of an SS/PBCH block specified by the radio base station. The SS/PBCH block may be specified by the SS/PBCH block information in the same frequency measurement information.

### <Different Frequency SS-RSRQ Measurement>

The user terminal may determine the maximum allowable band for NR carrier RSSI measurement to be an SS/PBCH block in a measurement target carrier. The user terminal may determine the maximum allowable bandwidth for NR carrier RSSI measurement to be the bandwidth of the SS/PBCH block in the measurement target carrier.

The SS/PBCH block in the measurement target carrier may be specified by the radio base station. For example, information related to different frequency measurement using an SS/PBCH block (also referred to as “different frequency measurement information,” “MeasObjectNR,” or the like) may be configured for the user terminal by higher layer signaling, and the different frequency measurement information may include information indicating that a measurement target signal is the SS/PBCH block and indicating the configuration of the SS/PBCH block (also referred to as “SS/PBCH block information,” “SSB-ConfigMobility,” and the like) and frequency position information (ssbFrequency) of the SS/PBCH block.

In the present disclosure, a description has been given of a configuration in which a plurality of carriers are included in one frequency range and a plurality of cells are included in one carrier. However, “frequency range,” “cell,” “serving cell,” “carrier,” and “CC” may be used interchangeably.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

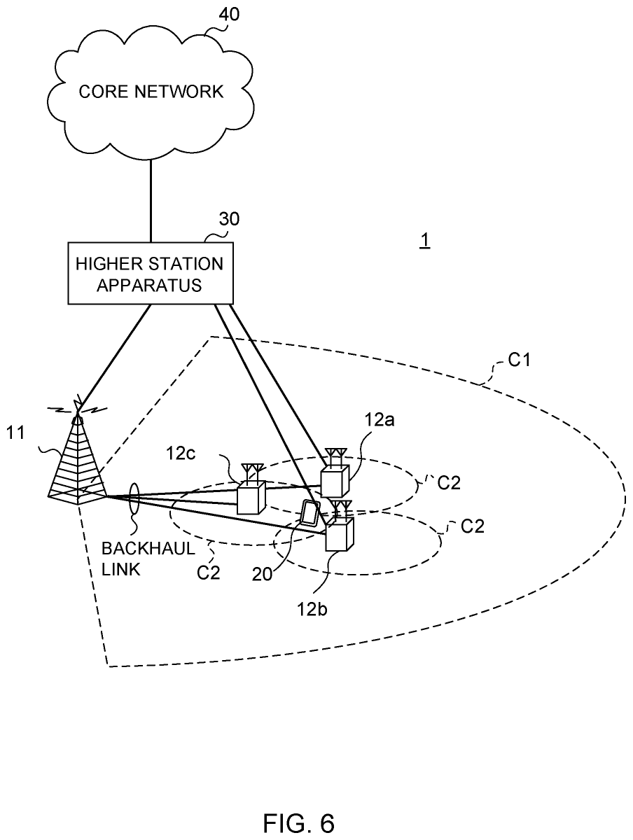

FIG. 6 is a diagram to show an example of a schematic structure of the radio communication system according to one embodiment. A radio communication system 1 can adopt carrier aggregation (CA) and/or dual connectivity (DC) to group a plurality of fundamental frequency blocks (component carriers) into one, where the system bandwidth in an LTE system (for example, 20 MHz) constitutes one unit.

Note that the radio communication system 1 may be referred to as “LTE (Long Term Evolution),” “LTE-A (LTE-Advanced),” “LTE-B (LTE-Beyond),” “SUPER 3G,” “IMT-Advanced,” “4G (4th generation mobile communication system),” “5G (5th generation mobile communication system),” “NR (New Radio),” “FRA (Future Radio Access),” “New-RAT (Radio Access Technology),” and so on, or may be referred to as a system implementing these.

The radio communication system 1 includes a radio base station 11 that forms a macro cell C1 of a relatively wide coverage, and radio base stations 12 (12a to 12c) that form small cells C2, which are placed within the macro cell C1 and which are narrower than the macro cell C1. Also, user terminals 20 are placed in the macro cell C1 and in each small cell C2. The arrangement, the number, and the like of each cell and user terminal 20 are by no means limited to the aspect shown in the diagram.

The user terminals 20 can connect with both the radio base station 11 and the radio base stations 12. It is assumed that the user terminals 20 use the macro cell C1 and the small cells C2 at the same time by means of CA or DC. The user terminals 20 can adopt CA or DC by using a plurality of cells (CCs).

Between the user terminals 20 and the radio base station 11, communication can be carried out by using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz, and so on) and a wide bandwidth may be used, or the same carrier as that used between the user terminals 20 and the radio base station 11 may be used. Note that the structure of the frequency band for use in each radio base station is by no means limited to these.

The user terminals 20 can perform communication by using time division duplex (TDD) and/or frequency division duplex (FDD) in each cell. Furthermore, in each cell (carrier), a single numerology may be employed, or a plurality of different numerologies may be employed.

Numerologies may be communication parameters applied to transmission and/or reception of a certain signal and/or channel, and for example, may indicate at least one of a subcarrier spacing, a bandwidth, a symbol length, a cyclic prefix length, a subframe length, a TTI length, the number of symbols per TTI, a radio frame structure, a particular filter processing performed by a transceiver in a frequency domain, a particular windowing processing performed by a transceiver in a time domain, and so on. For example, if certain physical channels use different subcarrier spacings of the OFDM symbols constituted and/or different numbers of the OFDM symbols, it may be referred to as that the numerologies are different.

A wired connection (for example, means in compliance with the CPRI (Common Public Radio Interface) such as an optical fiber, an X2 interface and so on) or a wireless connection may be established between the radio base station 11 and the radio base stations 12 (or between two radio base stations 12).

The radio base station 11 and the radio base stations 12 are each connected with a higher station apparatus 30, and are connected with a core network 40 via the higher station apparatus 30. Note that the higher station apparatus 30 may include, for example, access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB (eNodeB),” a “transmitting/receiving point” and so on. The radio base stations 12 are radio base stations having local coverages, and may be referred to as “small base stations,” “micro base stations,” “pico base stations,” “femto base stations,” “HeNBs (Home eNodeBs),” “RRHs (Remote Radio Heads),” “transmitting/receiving points” and so on. Hereinafter, the radio base stations 11 and 12 will be collectively referred to as “radio base stations 10,” unless specified otherwise.

Each of the user terminals 20 is a terminal that supports various communication schemes such as LTE and LTE-A, and may include not only mobile communication terminals (mobile stations) but stationary communication terminals (fixed stations).

In the radio communication system 1, as radio access schemes, orthogonal frequency division multiple access (OFDMA) is applied to the downlink, and single carrier frequency division multiple access (SC-FDMA) and/or OFDMA is applied to the uplink.

OFDMA is a multi-carrier communication scheme to perform communication by dividing a frequency band into a plurality of narrow frequency bands (subcarriers) and mapping data to each subcarrier. SC-FDMA is a single carrier communication scheme to mitigate interference between terminals by dividing the system bandwidth into bands formed with one or continuous resource blocks per terminal, and allowing a plurality of terminals to use mutually different bands. Note that the uplink and downlink radio access schemes are by no means limited to the combinations of these, and other radio access schemes may be used.

In the radio communication system 1, a downlink shared channel (PDSCH (Physical Downlink Shared Channel), which is used by each user terminal 20 on a shared basis, a broadcast channel (PBCH (Physical Broadcast Channel)), downlink L1/L2 control channels and so on, are used as downlink channels. User data, higher layer control information, SIBs (System Information Blocks) and so on are communicated on the PDSCH. The MIBs (Master Information Blocks) are communicated on the PBCH.

The downlink L1/L2 control channels include a PDCCH (Physical Downlink Control Channel), an EPDCCH (Enhanced Physical Downlink Control Channel), a PCFICH (Physical Control Format Indicator Channel), a PHICH (Physical Hybrid-ARQ Indicator Channel) and so on. Downlink control information (DCI), including PDSCH and/or PUSCH scheduling information, and so on are communicated on the PDCCH.

Note that the DCI scheduling DL data reception may be referred to as a “DL assignment,” and the DCI scheduling UL data transmission may be referred to as a “UL grant.”

The number of OFDM symbols to use for the PDCCH is communicated on the PCFICH. Transmission confirmation information (for example, also referred to as “retransmission control information,” “HARQ-ACK,” “ACK/NACK,” and so on) of HARQ (Hybrid Automatic Repeat reQuest) to a PUSCH is transmitted on the PHICH. The EPDCCH is frequency-division multiplexed with the PDSCH (downlink shared data channel) and used to communicate DCI and so on, like the PDCCH.

In the radio communication system 1, an uplink shared channel (PUSCH (Physical Uplink Shared Channel)), which is used by each user terminal 20 on a shared basis, an uplink control channel (PUCCH (Physical Uplink Control Channel)), a random access channel (PRACH (Physical Random Access Channel)) and so on are used as uplink channels. User data, higher layer control information and so on are communicated on the PUSCH. In addition, radio quality information (CQI (Channel Quality Indicator)) of the downlink, transmission confirmation information, scheduling request (SR), and so on are transmitted on the PUCCH. By means of the PRACH, random access preambles for establishing connections with cells are communicated.

In the radio communication system 1, a cell-specific reference signal (CRS), a channel state information-reference signal (CSI-RS), a demodulation reference signal (DMRS), a positioning reference signal (PRS), and so on are transmitted as downlink reference signals. In the radio communication system 1, a measurement reference signal (SRS (Sounding Reference Signal)), a demodulation reference signal (DMRS), and so on are transmitted as uplink reference signals. Note that DMRS may be referred to as a “user terminal specific reference signal (UE-specific Reference Signal).” Transmitted reference signals are by no means limited to these.

### <Radio Base Station>

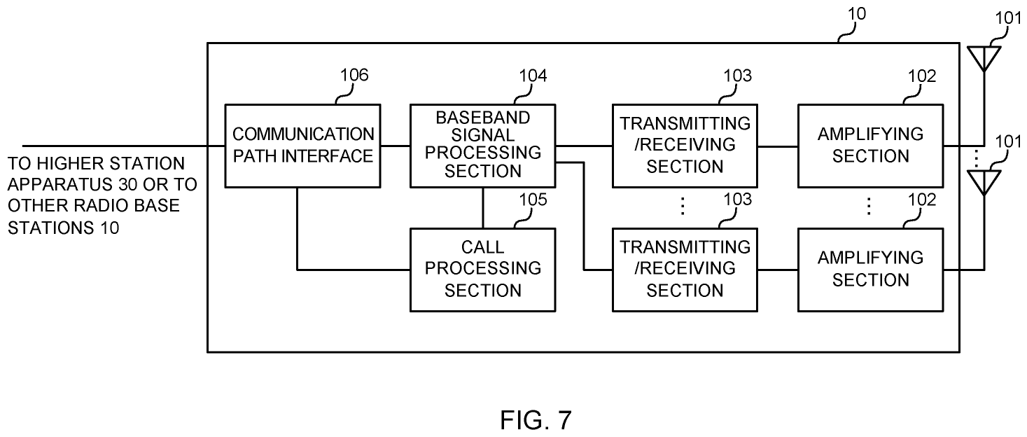

FIG. 7 is a diagram to show an example of an overall structure of the radio base station according to one embodiment. A radio base station 10 includes a plurality of transmitting/receiving antennas 101, amplifying sections 102, transmitting/receiving sections 103, a baseband signal processing section 104, a call processing section 105, and a communication path interface 106. Note that the radio base station 10 may be configured to include one or more transmitting/receiving antennas 101, one or more amplifying sections 102 and one or more transmitting/receiving sections 103.

User data to be transmitted from the radio base station 10 to the user terminal 20 by the downlink is input from the higher station apparatus 30 to the baseband signal processing section 104, via the communication path interface 106.

In the baseband signal processing section 104, the user data is subjected to transmission processes, such as a PDCP (Packet Data Convergence Protocol) layer process, division and coupling of the user data, RLC (Radio Link Control) layer transmission processes such as RLC retransmission control, MAC (Medium Access Control) retransmission control (for example, an HARQ transmission process), scheduling, transport format selection, channel coding, an inverse fast Fourier transform (IFFT) process, and a precoding process, and the result is forwarded to each transmitting/receiving section 103. Furthermore, downlink control signals are also subjected to transmission processes such as channel coding and inverse fast Fourier transform, and the result is forwarded to each transmitting/receiving section 103.

The transmitting/receiving sections 103 convert baseband signals that are pre-coded and output from the baseband signal processing section 104 on a per antenna basis, to have radio frequency bands and transmit the result. The radio frequency signals having been subjected to frequency conversion in the transmitting/receiving sections 103 are amplified in the amplifying sections 102, and transmitted from the transmitting/receiving antennas 101. The transmitting/receiving sections 103 can be constituted with transmitters/receivers, transmitting/receiving circuits or transmitting/receiving apparatus that can be described based on general understanding of the technical field to which the present disclosure pertains. Note that each transmitting/receiving section 103 may be structured as a transmitting/receiving section in one entity, or may be constituted with a transmitting section and a receiving section.

Meanwhile, as for uplink signals, radio frequency signals that are received in the transmitting/receiving antennas 101 are amplified in the amplifying sections 102. The transmitting/receiving sections 103 receive the uplink signals amplified in the amplifying sections 102. The transmitting/receiving sections 103 convert the received signals into the baseband signal through frequency conversion and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing (setting up, releasing, and so on) for communication channels, manages the state of the radio base station 10, manages the radio resources, and so on.

The communication path interface 106 transmits and/or receives signals to and/or from the higher station apparatus 30 via a certain interface. The communication path interface 106 may transmit and/or receive signals (backhaul signaling) with other radio base stations 10 via an inter-base station interface (for example, an optical fiber in compliance with the CPRI (Common Public Radio Interface) and an X2 interface).

Note that each of the transmitting/receiving sections 103 may further include an analog beamforming unit that conducts analog beamforming. The analog beamforming unit may be constituted of an analog beamforming circuit (for example, a phase shifter or a phase shift circuit) or analog beamforming apparatus (for example, phase shift equipment) that can be described based on general understanding of the technical field to which the present invention pertains. The transmitting/receiving antennas 101 may be constituted with, for example, array antennas.

The transmitting/receiving sections 103 transmit and/or receive data in a cell included in a carrier configured with an SMTC. The transmitting/receiving sections 103 may transmit information related to same frequency measurement and/or different frequency measurement and the like to the user terminals 20.

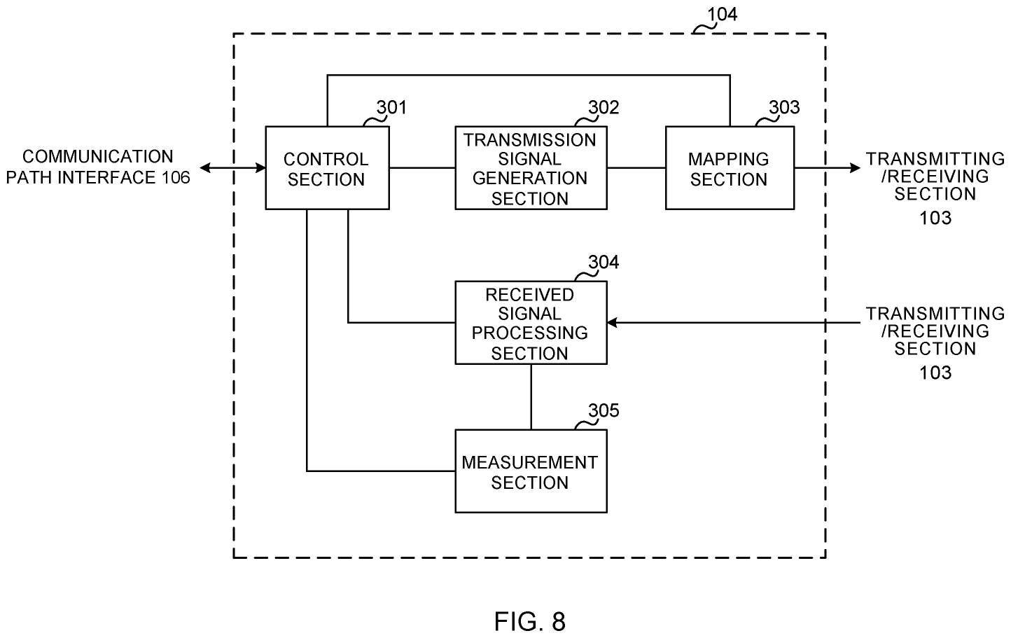

FIG. 8 is a diagram to show an example of a functional structure of the radio base station according to one embodiment of the present disclosure. Note that, the present example primarily shows functional blocks that pertain to characteristic parts of the present embodiment, and it is assumed that the radio base station 10 may include other functional blocks that are necessary for radio communication as well.

The baseband signal processing section 104 at least includes a control section (scheduler) 301, a transmission signal generation section 302, a mapping section 303, a received signal processing section 304, and a measurement section 305. Note that these structures may be included in the radio base station 10, and some or all of the structures do not need to be included in the baseband signal processing section 104.

The control section (scheduler) 301 controls the whole of the radio base station 10. The control section 301 can be constituted with a controller, a control circuit or control apparatus that can be described based on general understanding of the technical field to which the present disclosure pertains.

The control section 301, for example, controls the generation of signals in the transmission signal generation section 302, the mapping of signals by the mapping section 303, and so on. The control section 301 controls the signal receiving processes in the received signal processing section 304, the measurements of signals in the measurement section 305, and so on.

The control section 301 controls the scheduling (for example, resource assignment) of system information, a downlink data signal (for example, a signal transmitted on the PDSCH), a downlink control signal (for example, a signal transmitted on the PDCCH and/or the EPDCCH, such as transmission confirmation information). Based on the results of determining necessity or not of retransmission control to the uplink data signal, or the like, the control section 301 controls generation of a downlink control signal, a downlink data signal, and so on.

The control section 301 controls the scheduling of a synchronization signal (for example, PSS (Primary Synchronization Signal)/SSS (Secondary Synchronization Signal)), a downlink reference signal (for example, CRS, CSI-RS, DMRS), and so on.

The control section 301 controls the scheduling of an uplink data signal (for example, a signal transmitted on the PUSCH), an uplink control signal (for example, a signal transmitted on the PUCCH and/or the PUSCH, such as transmission confirmation information), a random access preamble (for example, a signal transmitted on the PRACH), an uplink reference signal, and the like.

The control section 301 may perform control of forming a transmit beam and/or a receive beam by using digital BF (for example, precoding) in the baseband signal processing section 104 and/or analog BF (for example, phase rotation) in the transmitting/receiving sections 103. The control section 301 may perform control of forming a beam, based on downlink channel information, uplink channel information, and the like. These kinds of channel information may be acquired from the received signal processing section 304 and/or the measurement section 305.

The control section 301 controls transmission of a synchronization signal. Specifically, the control section 301 controls at least one of generation and transmission of a synchronization signal block. The control section 301 may control reception of a measurement report including a received quality of a synchronization signal.

The transmission signal generation section 302 generates downlink signals (downlink control signals, downlink data signals, downlink reference signals and so on) based on commands from the control section 301 and outputs the downlink signals to the mapping section 303. The transmission signal generation section 302 can be constituted with a signal generator, a signal generation circuit or signal generation apparatus that can be described based on general understanding of the technical field to which the present disclosure pertains.

For example, the transmission signal generation section 302 generates DL assignment to report assignment information of downlink data and/or UL grant to report assignment information of uplink data, based on commands from the control section 301. The DL assignment and the UL grant are both DCI, and follow the DCI format. For a downlink data signal, encoding processing and modulation processing are performed in accordance with a coding rate, modulation scheme, or the like determined based on channel state information (CSI) from each user terminal 20.

The mapping section 303 maps the downlink signals generated in the transmission signal generation section 302 to certain radio resources, based on commands from the control section 301, and outputs these to the transmitting/receiving sections 103. The mapping section 303 can be constituted with a mapper, a mapping circuit or mapping apparatus that can be described based on general understanding of the technical field to which the present disclosure pertains.

The received signal processing section 304 performs receiving processes (for example, demapping, demodulation, decoding and so on) of received signals that are input from the transmitting/receiving sections 103. Here, the received signals are, for example, uplink signals that are transmitted from the user terminals 20 (uplink control signals, uplink data signals, uplink reference signals and so on). The received signal processing section 304 can be constituted with a signal processor, a signal processing circuit, or signal processing apparatus that can be described based on general understanding of the technical field to which the present disclosure pertains.

The received signal processing section 304 outputs the decoded information acquired through the receiving processes to the control section 301. For example, if the received signal processing section 304 receives the PUCCH including HARQ-ACK, the received signal processing section 304 outputs the HARQ-ACK to the control section 301. The received signal processing section 304 outputs the received signals and/or the signals after the receiving processes to the measurement section 305.

The measurement section 305 conducts measurements with respect to the received signals. The measurement section 305 can be constituted with a measurer, a measurement circuit or measurement apparatus that can be described based on general understanding of the technical field to which the present disclosure pertains.

For example, the measurement section 305 may perform RRM (Radio Resource Management) measurement, CSI (Channel State Information) measurement, and so on, based on the received signal. The measurement section 305 may measure a received power (for example, RSRP (Reference Signal Received Power)), a received quality (for example, RSRQ (Reference Signal Received Quality), an SINR (Signal to Interference plus Noise Ratio), an SNR (Signal to Noise Ratio)), a signal strength (for example, RSSI (Received Signal Strength Indicator)), channel information (for example, CSI), and so on. The measurement results may be output to the control section 301.

### <User Terminal>

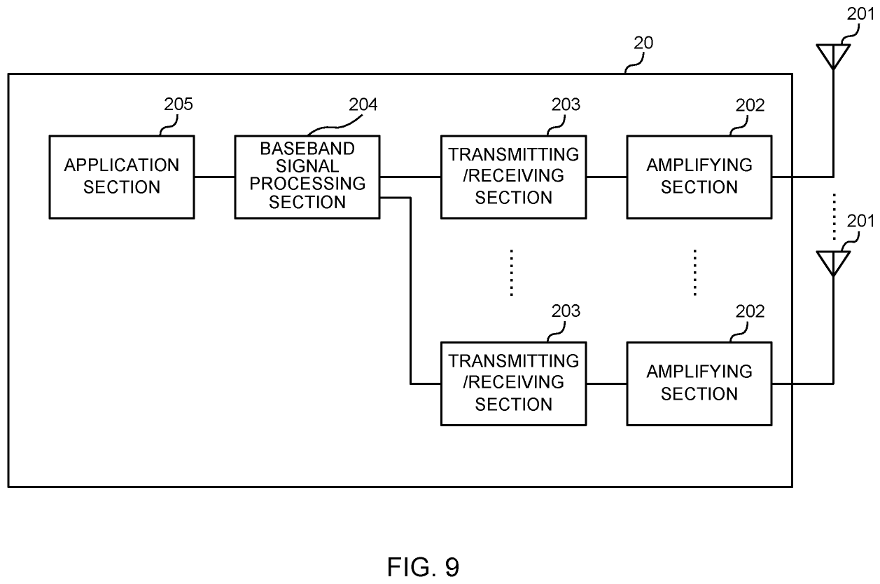

FIG. 9 is a diagram to show an example of an overall structure of a user terminal according to one embodiment. A user terminal 20 includes a plurality of transmitting/receiving antennas 201, amplifying sections 202, transmitting/receiving sections 203, a baseband signal processing section 204, and an application section 205. Note that the user terminal 20 may be configured to include one or more transmitting/receiving antennas 201, one or more amplifying sections 202, and one or more transmitting/receiving sections 203.

Radio frequency signals that are received in the transmitting/receiving antennas 201 are amplified in the amplifying sections 202. The transmitting/receiving sections 203 receive the downlink signals amplified in the amplifying sections 202. The transmitting/receiving sections 203 convert the received signals into baseband signals through frequency conversion, and output the baseband signals to the baseband signal processing section 204. The transmitting/receiving sections 203 can be constituted with transmitters/receivers, transmitting/receiving circuits or transmitting/receiving apparatus that can be described based on general understanding of the technical field to which the present disclosure pertains. Note that each transmitting/receiving section 203 may be structured as a transmitting/receiving section in one entity, or may be constituted with a transmitting section and a receiving section.

The baseband signal processing section 204 performs, on each input baseband signal, an FFT process, error correction decoding, a retransmission control receiving process, and so on. The downlink user data is forwarded to the application section 205. The application section 205 performs processes related to higher layers above the physical layer and the MAC layer, and so on. In the downlink data, broadcast information may be also forwarded to the application section 205.

Meanwhile, the uplink user data is input from the application section 205 to the baseband signal processing section 204. The baseband signal processing section 204 performs a retransmission control transmission process (for example, an HARQ transmission process), channel coding, precoding, a discrete Fourier transform (DFT) process, an IFFT process and so on, and the result is forwarded to the transmitting/receiving section 203.

The transmitting/receiving sections 203 convert the baseband signals output from the baseband signal processing section 204 to have radio frequency band and transmit the result. The radio frequency signals having been subjected to frequency conversion in the transmitting/receiving sections 203 are amplified in the amplifying sections 202, and transmitted from the transmitting/receiving antennas 201.

Note that each of the transmitting/receiving sections 203 may further include an analog beamforming unit that conducts analog beamforming. The analog beamforming unit may be constituted of an analog beamforming circuit (for example, a phase shifter or a phase shift circuit) or analog beamforming apparatus (for example, phase shift equipment) that can be described based on general understanding of the technical field to which the present invention pertains. The transmitting/receiving antennas 201 may be constituted with, for example, array antennas.

The transmitting/receiving sections 203 transmit and/or receive data in a cell included in a carrier configured with an SMTC. The transmitting/receiving sections 203 may receive information related to same frequency measurement and/or different frequency measurement and the like from the radio base station 10.

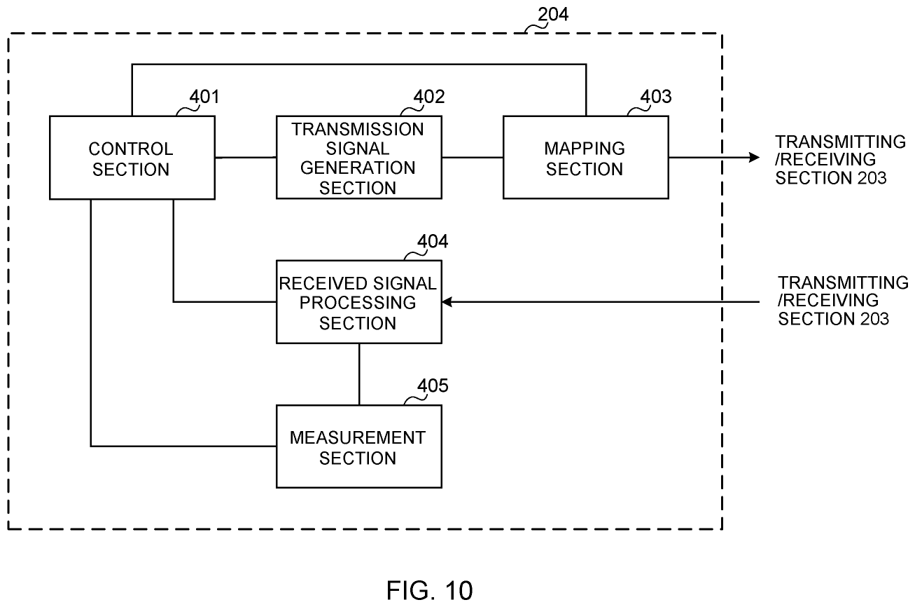

FIG. 10 is a diagram to show an example of a functional structure of the user terminal according to one embodiment. Note that, the present example primarily shows functional blocks that pertain to characteristic parts of the present embodiment, and it is assumed that the user terminal 20 may include other functional blocks that are necessary for radio communication as well.

The baseband signal processing section 204 provided in the user terminal 20 at least includes a control section 401, a transmission signal generation section 402, a mapping section 403, a received signal processing section 404 and a measurement section 405. Note that these structures may be included in the user terminal 20, and some or all of the structures do not need to be included in the baseband signal processing section 204.

The control section 401 controls the whole of the user terminal 20. The control section 401 can be constituted with a controller, a control circuit, or control apparatus that can be described based on general understanding of the technical field to which the present disclosure pertains.

The control section 401, for example, controls the generation of signals in the transmission signal generation section 402, the mapping of signals in the mapping section 403, and so on. The control section 401 controls the signal receiving processes in the received signal processing section 404, the measurements of signals in the measurement section 405, and so on.

The control section 401 acquires a downlink control signal and a downlink data signal transmitted from the radio base station 10, from the received signal processing section 404. The control section 401 controls generation of an uplink control signal and/or an uplink data signal, based on the results of determining necessity or not of retransmission control to a downlink control signal and/or a downlink data signal.

The control section 401 may perform control of forming a transmit beam and/or a receive beam by using digital BF (for example, precoding) in the baseband signal processing section 204 and/or analog BF (for example, phase rotation) in the transmitting/receiving sections 203. The control section 401 may perform control of forming a beam, based on downlink channel information, uplink channel information, and the like. These kinds of channel information may be acquired from the received signal processing section 404 and/or the measurement section 405.

The control section 401 may determine a maximum allowable bandwidth for measurement of a received signal strength to be used for determination of a received quality of the synchronization signal.

In a case that an activated band (e.g., an active DL BWP) in a carrier includes a synchronization signal block, the control section 401 may determine the maximum allowable bandwidth to be a bandwidth of the activated band (first aspect).

In a case that an activated band in a carrier does not include a synchronization signal block, the control section 401 may determine the maximum allowable bandwidth, based on whether a bandwidth of at least one band configured for the user terminal (for example, a configured DL BWP) includes a synchronization signal block (first aspect).

In a case that each of all bands configured for the user terminal in a carrier includes a synchronization signal block, the control section 401 may determine the maximum allowable bandwidth to be a bandwidth of an activated band or a smallest or greatest bandwidth of all the bands (second aspect).

In a case that at least one band configured for the user terminal in a carrier does not include a synchronization signal block, the control section 401 may determine the maximum allowable bandwidth to be any one of a bandwidth of the synchronization signal block, a smallest or greatest bandwidth configured for the user terminal in the carrier and including the synchronization signal block, and a bandwidth of a control resource set specified by a broadcast channel in the synchronization signal block (second aspect).

If the control section 401 acquires a variety of information reported by the radio base station 10 from the received signal processing section 404, the control section 401 may update parameters to use for control, based on the information.

The transmission signal generation section 402 generates uplink signals (uplink control signals, uplink data signals, uplink reference signals and so on) based on commands from the control section 401, and outputs the uplink signals to the mapping section 403. The transmission signal generation section 402 can be constituted with a signal generator, a signal generation circuit, or signal generation apparatus that can be described based on general understanding of the technical field to which the present disclosure pertains.

For example, the transmission signal generation section 402 generates an uplink control signal about transmission confirmation information, the channel state information (CSI), and so on, based on commands from the control section 401. The transmission signal generation section 402 generates uplink data signals, based on commands from the control section 401. For example, when a UL grant is included in a downlink control signal that is reported from the radio base station 10, the control section 401 commands the transmission signal generation section 402 to generate the uplink data signal.

The mapping section 403 maps the uplink signals generated in the transmission signal generation section 402 to radio resources, based on commands from the control section 401, and outputs the result to the transmitting/receiving sections 203. The mapping section 403 can be constituted with a mapper, a mapping circuit, or mapping apparatus that can be described based on general understanding of the technical field to which the present disclosure pertains.

The received signal processing section 404 performs receiving processes (for example, demapping, demodulation, decoding, and so on) of received signals that are input from the transmitting/receiving sections 203. Here, the received signals are, for example, downlink signals transmitted from the radio base station 10 (downlink control signals, downlink data signals, downlink reference signals and so on). The received signal processing section 404 can be constituted with a signal processor, a signal processing circuit or signal processing apparatus that can be described based on general understanding of the technical field to which the present disclosure pertains. The received signal processing section 404 can constitute the receiving section according to the present disclosure.

The received signal processing section 404 outputs the decoded information acquired through the receiving processes to the control section 401. The received signal processing section 404 outputs, for example, broadcast information, system information, RRC signaling, DCI and so on, to the control section 401. The received signal processing section 404 outputs the received signals and/or the signals after the receiving processes to the measurement section 405.

The measurement section 405 conducts measurements with respect to the received signals. For example, the measurement section 405 may perform same frequency measurement and/or different frequency measurement using an SSB for one of or both a first carrier and a second carrier. The measurement section 405 can be constituted with a measurer, a measurement circuit, or measurement apparatus that can be described based on general understanding of the technical field to which the present disclosure pertains.

For example, the measurement section 405 may perform RRM measurement, CSI measurement, and so on, based on the received signal. The measurement section 405 may measure a received power (for example, RSRP), a received quality (for example, RSRQ, SINR, SNR), a signal strength (for example, RSSI), channel information (for example, CSI), and so on. The measurement results may be output to the control section 401.

### <Hardware Structure>

Note that the block diagrams that have been used to describe the above embodiments show blocks in functional units. These functional blocks (components) may be implemented in arbitrary combinations of hardware and/or software. Also, the method for implementing each functional block is not particularly limited. That is, each functional block may be realized by one piece of apparatus that is physically and/or logically aggregated, or may be realized by directly and/or indirectly connecting two or more physically and/or logically separate pieces of apparatus (via wire and/or wireless, for example) and using these plurality of pieces of apparatus.

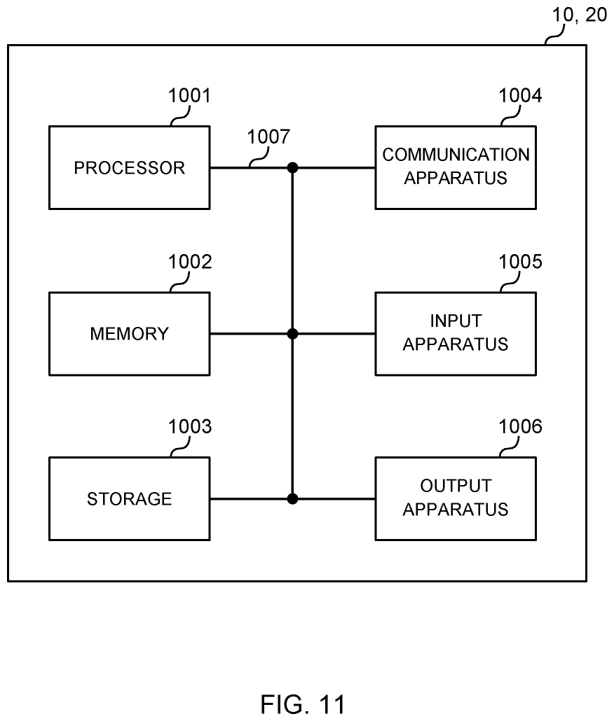

For example, a radio base station, a user terminal, and so on according to one embodiment of the present disclosure may function as a computer that executes the processes of the radio communication method of the present disclosure. FIG. 11 is a diagram to show an example of a hardware structure of the radio base station and the user terminal according to one embodiment. Physically, the above-described radio base station 10 and user terminals 20 may each be formed as computer apparatus that includes a processor 1001, a memory 1002, a storage 1003, a communication apparatus 1004, an input apparatus 1005, an output apparatus 1006, a bus 1007, and so on.

Note that, in the following description, the word “apparatus” may be interpreted as “circuit,” “device,” “unit,” and so on. The hardware structure of the radio base station 10 and the user terminals 20 may be designed to include one or a plurality of apparatuses shown in the drawings, or may be designed not to include part of pieces of apparatus.

For example, although only one processor 1001 is shown, a plurality of processors may be provided. Furthermore, processes may be implemented with one processor or may be implemented at the same time, in sequence, or in different manners with one or more processors. Note that the processor 1001 may be implemented with one or more chips.

Each function of the radio base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and read and/or write data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, the above-described baseband signal processing section 104 (204), call processing section 105, and so on may be implemented by the processor 1001.

Furthermore, the processor 1001 reads programs (program codes), software modules, data, and so on from the storage 1003 and/or the communication apparatus 1004, into the memory 1002, and executes various processes according to these. As for the programs, programs to allow computers to execute at least part of the operations of the above-described embodiments are used. For example, the control section 401 of each user terminal 20 may be implemented by control programs that are stored in the memory 1002 and that operate on the processor 1001, and other functional blocks may be implemented likewise.

The memory 1002 is a computer-readable recording medium, and may be constituted with, for example, at least one of a ROM (Read Only Memory), an EPROM (Erasable Programmable ROM), an EEPROM (Electrically EPROM), a RAM (Random Access Memory), and other appropriate storage media. The memory 1002 may be referred to as a “register,” a “cache,” a “main memory (primary storage apparatus)” and so on. The memory 1002 can store executable programs (program codes), software modules, and/or the like for implementing a radio communication method according to one embodiment.

The storage 1003 is a computer-readable recording medium, and may be constituted with, for example, at least one of a flexible disk, a floppy (registered trademark) disk, a magneto-optical disk (for example, a compact disc (CD-ROM (Compact Disc ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via wired and/or wireless networks, and may be referred to as, for example, a “network device,” a “network controller,” a “network card,” a “communication module” and so on. The communication apparatus 1004 may be configured to include a high frequency switch, a duplexer, a filter, a frequency synthesizer, and so on in order to realize, for example, frequency division duplex (FDD) and/or time division duplex (TDD). For example, the above-described transmitting/receiving antennas 101 (201), amplifying sections 102 (202), transmitting/receiving sections 103 (203), communication path interface 106, and so on may be implemented by the communication apparatus 1004.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, an LED (Light Emitting Diode) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the radio base station 10 and the user terminals 20 may be structured to include hardware such as a microprocessor, a digital signal processor (DSP), an ASIC (Application Specific Integrated Circuit), a PLD (Programmable Logic Device), an FPGA (Field Programmable Gate Array), and so on, and part or all of the functional blocks may be implemented by the hardware. For example, the processor 1001 may be implemented with at least one of these pieces of hardware.

### (Variations)

Note that the terminology described in this specification and/or the terminology that is needed to understand this specification may be replaced by other terms that convey the same or similar meanings. For example, “channels” and/or “symbols” may be replaced by “signals” (“signaling”). Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

Furthermore, a radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may have a fixed time length (for example, 1 ms) independent of numerology.

Furthermore, a slot may be constituted of one or a plurality of symbols in the time domain (OFDM (Orthogonal Frequency Division Multiplexing) symbols, SC-FDMA (Single Carrier Frequency Division Multiple Access) symbols, and so on). Furthermore, a slot may be a time unit based on numerology. A slot may include a plurality of mini-slots. Each mini-slot may be constituted of one or a plurality of symbols in the time domain. A mini-slot may be referred to as a “sub-slot.”

A radio frame, a subframe, a slot, a mini-slot, and a symbol all express time units in signal communication. A radio frame, a subframe, a slot, a mini-slot, and a symbol may each be called by other applicable terms. For example, one subframe may be referred to as a “transmission time interval (TTI),” a plurality of consecutive subframes may be referred to as a “TTI” or one slot or one mini-slot may be referred to as a “TTI.” That is, a subframe and/or a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a radio base station schedules the allocation of radio resources (such as a frequency bandwidth and transmission power that are available for each user terminal) for the user terminal in TTI units. Note that the definition of TTIs is not limited to this.

TTIs may be transmission time units for channel-encoded data packets (transport blocks), code blocks, and/or codewords, or may be the unit of processing in scheduling, link adaptation, and so on. Note that, when TTIs are given, the time interval (for example, the number of symbols) to which transport blocks, code blocks and/or codewords are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “common TTI” (TTI in LTE Rel. 8 to Rel. 12), a “normal TTI,” a “long TTI,” a “common subframe,” a “normal subframe,” a “long subframe” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. Also, an RB may include one or a plurality of symbols in the time domain, and may be one slot, one mini-slot, one subframe, or one TTI in length. One TTI and one subframe each may be constituted of one or a plurality of resource blocks. Note that one or a plurality of RBs may be referred to as a “physical resource block (PRB (Physical RB)),” a “sub-carrier group (SCG),” a “resource element group (REG),” a “PRB pair,” an “RB pair,” and so on.

Furthermore, a resource block may be constituted of one or a plurality of resource elements (REs). For example, one RE may correspond to a radio resource field of one subcarrier and one symbol.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in this specification may be represented in absolute values or in relative values with respect to certain values, or may be represented in another corresponding information. For example, radio resources may be specified by certain indices.

The names used for parameters and so on in this specification are in no respect limiting. For example, since various channels (PUCCH (Physical Uplink Control Channel), PDCCH (Physical Downlink Control Channel), and so on) and information elements can be identified by any suitable names, the various names assigned to these individual channels and information elements are in no respect limiting.

The information, signals, and/or others described in this specification may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output from higher layers to lower layers and/or from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in this specification, and other methods may be used as well. For example, reporting of information may be implemented by using physical layer signaling (for example, downlink control information (DCI), uplink control information (UCI), higher layer signaling (for example, RRC (Radio Resource Control) signaling, broadcast information (master information block (MIB), system information blocks (SIBs), and so on), MAC (Medium Access Control) signaling and so on), and other signals and/or combinations of these.

Note that physical layer signaling may be referred to as “L1/L2 (Layer 1/Layer 2) control information (L1/L2 control signals),” “L1 control information (L1 control signal),” and so on. Also, RRC signaling may be referred to as an “RRC message,” and can be, for example, an RRC connection setup (RRCConnectionSetup) message, an RRC connection reconfiguration (RRCConnectionReconfiguration) message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using wired technologies (coaxial cables, optical fiber cables, twisted-pair cables, digital subscriber lines (DSL), and so on) and/or wireless technologies (infrared radiation, microwaves, and so on), these wired technologies and/or wireless technologies are also included in the definition of communication media.

The terms “system” and “network” as used in this specification are used interchangeably.

In the present specification, the terms “base station (BS),” “radio base station,” “eNB,” “gNB,” “cell,” “sector,” “cell group,” “carrier,” and “component carrier” may be used interchangeably. A base station may be referred to as a “fixed station,” “NodeB,” “eNodeB (eNB),” “access point,” “transmission point,” “receiving point,” “femto cell,” “small cell” and so on.

A base station can accommodate one or a plurality of (for example, three) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs (Remote Radio Heads))). The term “cell” or “sector” refers to part of or the entire coverage area of a base station and/or a base station subsystem that provides communication services within this coverage.

In the present specification, the terms “mobile station (MS),” “user terminal,” “user equipment (UE),” and “terminal” may be used interchangeably.

A mobile station may be referred to as, by a person skilled in the art, a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

Furthermore, the radio base stations in this specification may be interpreted as user terminals. For example, each aspect/embodiment of the present disclosure may be applied to a configuration in which communication between a radio base station and a user terminal is replaced with communication among a plurality of user terminals (D2D (Device-to-Device)). In this case, the user terminals 20 may have the functions of the radio base stations 10 described above. In addition, wording such as “uplink” and “downlink” may be interpreted as “side.” For example, an uplink channel may be interpreted as a side channel.

Likewise, the user terminals in this specification may be interpreted as radio base stations. In this case, the radio base stations 10 may have the functions of the user terminals 20 described above.

Actions which have been described in this specification to be performed by a base station may, in some cases, be performed by upper nodes. In a network including one or a plurality of network nodes with base stations, it is clear that various operations that are performed to communicate with terminals can be performed by base stations, one or more network nodes (for example, MMEs (Mobility Management Entities), S-GW (Serving-Gateways), and so on may be possible, but these are not limiting) other than base stations, or combinations of these.

The aspects/embodiments illustrated in this specification may be used individually or in combinations, which may be switched depending on the mode of implementation. The order of processes, sequences, flowcharts, and so on that have been used to describe the aspects/embodiments herein may be re-ordered as long as inconsistencies do not arise. For example, although various methods have been illustrated in this specification with various components of steps in exemplary orders, the specific orders that are illustrated herein are by no means limiting.

The aspects/embodiments illustrated in this specification may be applied to LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR (New Radio), NX (New radio access), FX (Future generation radio access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), systems that use other adequate radio communication methods and/or next-generation systems that are enhanced based on these.

The phrase “based on” (or “on the basis of”) as used in this specification does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second” and so on as used herein does not generally limit the quantity or order of these elements. These designations may be used herein only for convenience, as a method for distinguishing between two or more elements. Thus, reference to the first and second elements does not imply that only two elements may be employed, or that the first element must precede the second element in some way.

The term “judging (determining)” as used herein may encompass a wide variety of actions. For example, “judging (determining)” may be interpreted to mean making “judgments (determinations)” about calculating, computing, processing, deriving, investigating, looking up (for example, searching a table, a database, or some other data structures), ascertaining, and so on. Furthermore, “judging (determining)” may be interpreted to mean making “judgments (determinations)” about receiving (for example, receiving information), transmitting (for example, transmitting information), input, output, accessing (for example, accessing data in a memory), and so on. In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

The terms “connected” and “coupled,” or any variation of these terms as used herein mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In this specification, when two elements are connected, the two elements may be considered “connected” or “coupled” to each other by using one or more electrical wires, cables and/or printed electrical connections, and, as some non-limiting and non-inclusive examples, by using electromagnetic energy having wavelengths in radio frequency regions, microwave regions, (both visible and invisible) optical regions, or the like.

In this specification, the phrase “A and B are different” may mean that “A and B are different from each other.” The terms “separate,” “be coupled” and so on may be interpreted similarly.

When terms such as “including,” “comprising,” and variations of these are used in this specification or in claims, these terms are intended to be inclusive, in a manner similar to the way the term “provide” is used. Furthermore, the term “or” as used in this specification or in claims is intended to be not an exclusive disjunction.

Now, although the invention according to the present disclosure has been described in detail above, it should be obvious to a person skilled in the art that the invention according to the present disclosure is by no means limited to the embodiments described in this specification. The invention according to the present disclosure can be implemented with various corrections and in various modifications, without departing from the spirit and scope of the invention defined by the recitations of claims. Consequently, the description in this specification is provided only for the purpose of explaining examples, and should by no means be construed to limit the invention according to the present disclosure in any way.

1. A user terminal comprising:
a receiving section that receives a synchronization signal; and
a control section that determines a maximum allowable bandwidth for measurement of a received signal strength to be used for determination of a received quality of the synchronization signal.

2. The user terminal according to claim 1, wherein
in a case that an activated band in a carrier includes a synchronization signal block, the control section determines the maximum allowable bandwidth to be a bandwidth of the activated band.

3. The user terminal according to claim 1, wherein
in a case that an activated band in a carrier does not include a synchronization signal block, the control section determines the maximum allowable bandwidth, based on whether a bandwidth of at least one band configured for the user terminal includes a synchronization signal block.

4. The user terminal according to claim 1, wherein
in a case that all bands configured for the user terminal in a carrier include a synchronization signal block, the control section determines the maximum allowable bandwidth to be a bandwidth of an activated band or a smallest or greatest bandwidth of all the bands.

5. The user terminal according to claim 1, wherein
in a case that at least one band configured for the user terminal in a carrier does not include a synchronization signal block, the control section determines the maximum allowable bandwidth to be any one of a bandwidth of the synchronization signal block, a smallest or greatest bandwidth configured for the user terminal in the carrier and including the synchronization signal block, and a bandwidth of a control resource set specified by a broadcast channel in the synchronization signal block.

6. A radio base station comprising:
a transmitting section that transmits a synchronization signal; and
a receiving section that receives a measurement report including a received quality of the synchronization signal, the received quality being determined based on a received signal strength measured by using a maximum allowable bandwidth determined by a user terminal.

7. The user terminal according to claim 2, wherein
in a case that an activated band in a carrier does not include a synchronization signal block, the control section determines the maximum allowable bandwidth, based on whether a bandwidth of at least one band configured for the user terminal includes a synchronization signal block.

8. The user terminal according to claim 4, wherein
in a case that at least one band configured for the user terminal in a carrier does not include a synchronization signal block, the control section determines the maximum allowable bandwidth to be any one of a bandwidth of the synchronization signal block, a smallest or greatest bandwidth configured for the user terminal in the carrier and including the synchronization signal block, and a bandwidth of a control resource set specified by a broadcast channel in the synchronization signal block.
